(19) United States
(12) Patent Application Publication
(10) Pub. No.: US 2011/0277900 A1
(43) Pub. Date: Nov. 17, 2011

(54) PUNCTURE PREVENTING TIRE

(76) Inventor: CHUN-FU KUO, Taichung Hsien (TW)

(21) Appl. No.: 12/781,788

(22) Filed: May 17, 2010

(51) Int. Cl. B60C 19/12

(52) U.S. Cl. 152/502

(57) ABSTRACT

The puncture preventing tire of the present invention includes an annular tire body and a reinforced sealant layer. The tire body has an inner surface which defines an air chamber. The reinforced sealant layer is attached to the inner surface of the tire body to at least partially cover the inner surface. The reinforced sealant layer includes high viscosity sealant and multiple stationary posts. The stationary posts are circumferentially spread on the inner surface and are surrounded by the high viscosity sealant. Therefore, the sealant can be adequately supported by the stationary posts, and the sealant layer may not be deformed during the rapid rotation of the tire when the tire has not been punctured yet.

### BACKGROUND OF THE INVENTION

1. Field of the Invention

The present invention relates to a tire, and more particularly to a puncture preventing tire.

2. Description of the Prior Art

Conventional tires may be manufactured to have puncture preventing properties by disposing a sealant in an inner layer of the tire body, as shown in solid line of FIG. 1. However, the balance loss of the tire is commonly seen when the tire rotates quickly, manly because the centrifugal force and the high temperature environment cause the sealant to uniformly distribute over the inner tire surface, as shown in the dotted line of FIG. 1. What's worse, the sealant might delaminate from the inner tire surface, which seriously affects the driving safety.

The present invention is, therefore, arisen to obviate or at least mitigate the above mentioned disadvantages.

### SUMMARY OF THE INVENTION

The main object of the present invention is to provide a puncture preventing tire whose sealant layer is substantially prohibited from deformation when the tire has not been punctured yet.

To achieve the above and other objects, a puncture preventing tire of the present invention includes an annular tire body and a reinforced sealant layer. The tire body has an inner surface which defines an air chamber. The reinforced sealant layer is attached to the inner surface of the tire body to at least partially cover the inner surface. The reinforced sealant layer includes high viscosity sealant and multiple stationary posts. The stationary posts are circumferentially spread on the inner surface and are surrounded by the high viscosity sealant.

As such, the sealant can be supported by the stationary posts, and thus the sealant layer may not be deformed during the rapid rotation of the tire when the tire has not been punctured yet.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a profile showing a puncture preventing tire of the prior art;

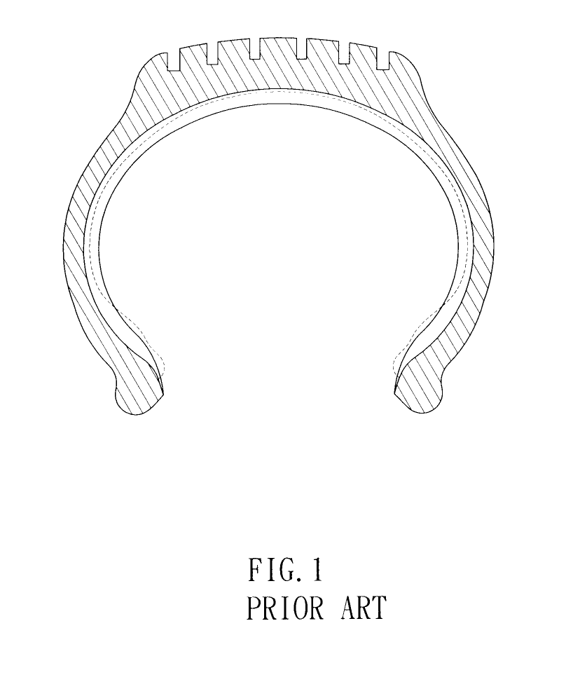

FIG. 2 is a partial perspective drawing showing a puncture preventing tire of the present invention;

FIG. 3 is a profile showing a puncture preventing tire of the present invention;

FIG. 4 is a partial profile showing a puncture preventing tire of the present invention;

FIG. 5 is a partial profile showing another puncture preventing tire of the present invention.

### DETAILED DESCRIPTION OF THE PREFERRED EMBODIMENTS

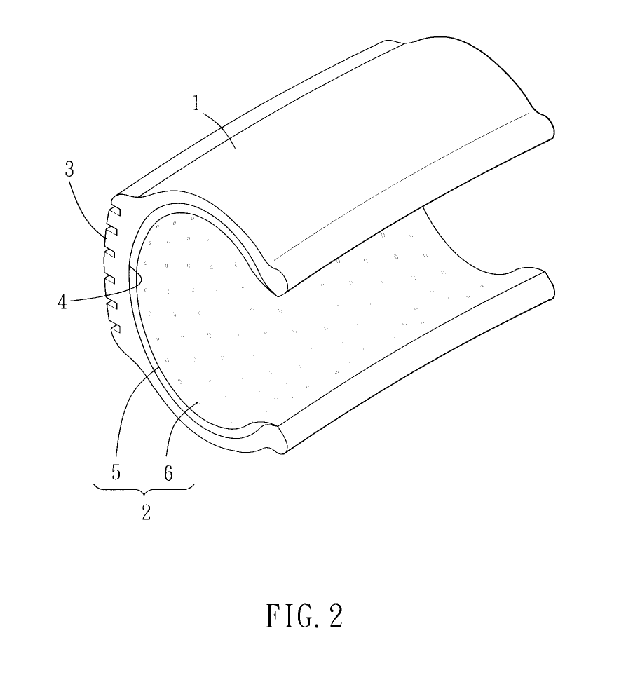

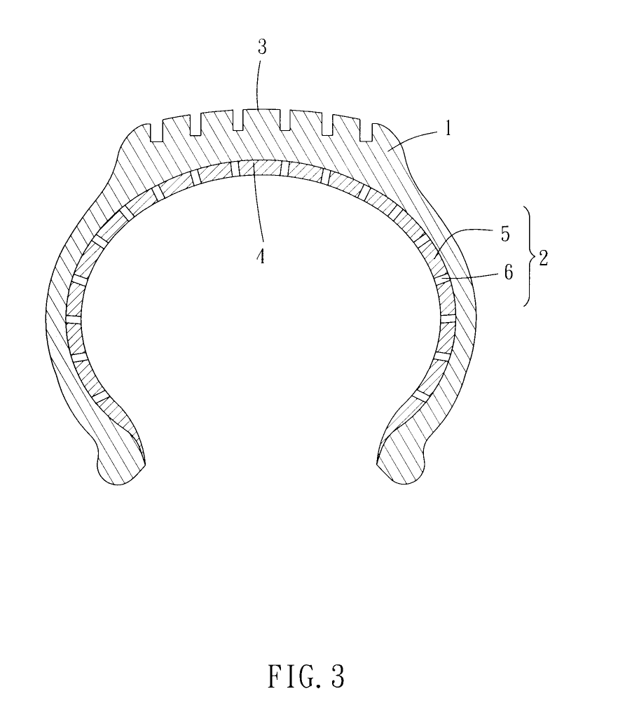

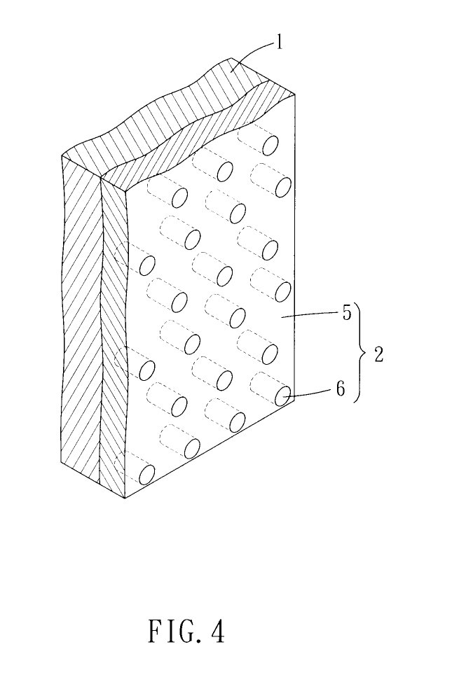

Please refer to FIG. 2 to FIG. 4. A puncture preventing tire of the present invention includes an annular tire body 1, in which FIG. 2 shows only a section thereof, and a reinforced sealant layer 2.

The annular tire body 1 has an outer surface 3 and an inner surface 4. The outer surface 3 may be formed with grooves that are adapted to increase friction to the ground. The tire body 1 may be made from single rubber material. The inner surface 4 defines an air chamber therein.

The reinforced sealant layer 2 is attached to the inner surface 4 of the tire body 1 to substantially fully cover the inner surface 4. In other words, the air chamber is somewhat surrounded by the reinforced sealant layer 2. The reinforced sealant layer 2 includes high viscosity sealant 5 and multiple stationary posts 6. The stationary posts 6 are circumferentially spread on the inner surface 4 and being surrounded by the high viscosity sealant 5. To make the stationary posts 6 immobile, the stationary posts 6 may be integrally extended from the inner surface 4 of the tire body 1. In this case, the stationary posts 6 are made from the same material as are the tire body 1. In other possible embodiments of the present invention, the posts 6 may be solid posts fixedly disposed on the inner surface 4. For example, the posts 6 may be threaded or nailed on the inner surface 4. In the present embodiment, the stationary posts 6 are flush with the high viscosity sealant 5, thus the distal ends thereof are somewhat exposed to the air chamber. In other embodiments of the present invention, the stationary posts 6 may be partially protrusive from the high viscosity sealant 5 or be fully covered by the high viscosity sealant 5. The high viscosity sealant 5 is preferably made from polyurethane and can endure at least 120 degree Celsius without being melted. Further, the high viscosity sealant 5 may be a foamed structure with closed cells, which can reduce its weight without scarifying its sealing property.

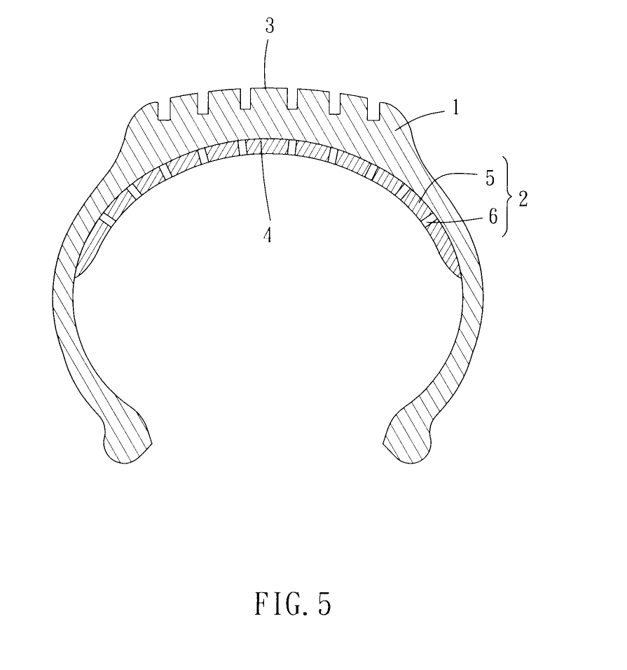

Please refer to FIG. 5. In another embodiment of the present invention, the reinforced sealant layer 2 merely covers a central portion of the inner surface 4. Specifically, the central portion of the inner surface 4 corresponds to a contacting portion of the outer surface 3 which is adapted to directly contact the ground. Such contacting portion is more likely to be punctured. With the reinforced sealant layer 2 being attached to the central portion of the inner surface 4, the tire can still achieve puncture preventing effect.

When the tire of the present invention is rotated rapidly, the temperature of the tire may rises to more than 100 degree Celsius. Thus the centrifugal force and the high temperature can possibly cause a sealant layer of a conventional tire to deform, which will further cause the balance loss of the tire, as discussed hereinabove. However, the reinforced sealant layer of the present invention has elevated ability to resist the centrifugal force and the high temperature. More specifically, the stationary posts remain immobile during the rapid rotation of the tire, while the high viscosity sealant can be adequately supported by the posts. Further, the centrifugal force can be adequately absorbed by the stationary posts. As a result, the high viscosity sealant will not deform as conventional sealant structure. Nevertheless, the high viscosity sealant can still fill into the hole once the tire is punctured by an object, preventing the tire from deflating. Therefore, the driving safety can be ensured, both in the sealant layer stability and the puncture preventing properties.

What is claimed is:

1. A puncture preventing tire, comprising:
an annular tire body, the annular tire body having an inner surface defining an air chamber;
a reinforced sealant layer, being attached to the inner surface of the tire body to at least partially cover the inner surface, the reinforced sealant layer comprising high viscosity sealant and multiple stationary posts, the stationary posts being circumferentially spread on the inner surface and being surrounded by the high viscosity sealant.

2. The puncture preventing tire of claim 1, wherein the stationary posts are integrally extended from the inner surface of the tire body.

3. The puncture preventing tire of claim 1, wherein the high viscosity sealant is polyurethane.

4. The puncture preventing tire of claim 1, wherein the high viscosity sealant is able to endure 120 degree Celsius without being melted.

5. The puncture preventing tire of claim 1, wherein the stationary posts are partially protrusive from the high viscosity sealant.

6. The puncture preventing tire of claim 1, wherein the stationary posts are fully covered by the high viscosity sealant.
